(19) United States
(12) Patent Application Publication
(10) Pub. No.: US 2025/0008316 A1
(43) Pub. Date: Jan. 2, 2025

(54) METHOD, APPARATUS, DEVICE, STORAGE MEDIUM, AND PROGRAM PRODUCT FOR INFORMATION SHARING

(71) Applicant: TENCENT TECHNOLOGY (SHENZHEN) COMPANY LIMITED, Shenzhen (CN)

(72) Inventors: Chengliu XIAO, Shenzhen (CN); Bukai LIN, Shenzhen (CN)

(21) Appl. No.: 18/734,671

(22) Filed: Jun. 5, 2024

Related U.S. Application Data
(63) Continuation of application No. PCT/CN2023/114253, filed on Aug. 22, 2023.

(30) Foreign Application Priority Data
Sep. 20, 2022 (CN) 202211141603.4

(51) Int. Cl. H04W 8/20; G06F 9/54; H04M 1/72436; H04M 1/72469

(52) U.S. Cl. CPC H04W 8/20; G06F 9/547; H04M 1/72436; H04M 1/72469

(57) ABSTRACT

A method for information sharing, executed by a first terminal, includes displaying an application interface that includes a sharing target selection control and a sharing information selection control, determining at least one type of target information for sharing from at least two types of candidate information of the first terminal in response to receipt of a selection operation on the sharing information selection control, displaying a list of sharing targets in response to receipt of a selection operation on the sharing target selection control, receiving a selection operation on one sharing target in the list of sharing targets, and transmitting a share link for obtaining the at least one type of target information to a second terminal corresponding to the one sharing target.

### CROSS-REFERENCE TO RELATED APPLICATIONS

This application is a continuation of International Application No. PCT/CN2023/114253, filed on Aug. 22, 2023, which claims priority to Chinese Patent Application No. 202211141603.4, filed with the China National Intellectual Property Administration on Sep. 20, 2022 and entitled “METHOD, APPARATUS, DEVICE, STORAGE MEDIUM, AND PROGRAM PRODUCT FOR INFORMATION SHARING,” the entire contents of both of which are incorporated herein by reference.

### FIELD OF THE TECHNOLOGY

This application relates to the technical field of interface interactions, and in particular, to a method, an apparatus, a device, a storage medium, and a program product for information sharing.

### BACKGROUND OF THE DISCLOSURE

With the continuous development of mobile terminal technologies, mobile terminals have been widely used in scenarios such as child/elderly monitoring and safe traveling.

In the related art, the scenarios such as child/elderly monitoring and safe traveling may be achieved through location information of mobile terminals such as wearable devices (for example, smartwatches) worn by monitored objects. For example, a wearable device may report itinerary related information to a cloud server, and the cloud server transmits the itinerary related information to a terminal bound to the wearable device.

However, in the foregoing solution, the terminal needs to be bound in advance, and the information transmitted is relatively single, resulting in a low efficiency of information sharing.

### SUMMARY

In accordance with the disclosure, there is provided a method for information sharing, executed by a first terminal, including displaying an application interface that includes a sharing target selection control and a sharing information selection control, determining at least one type of target information for sharing from at least two types of candidate information of the first terminal in response to receipt of a selection operation on the sharing information selection control, displaying a list of sharing targets in response to receipt of a selection operation on the sharing target selection control, receiving a selection operation on one sharing target in the list of sharing targets, and transmitting a share link for obtaining the at least one type of target information to a second terminal corresponding to the one sharing target.

Also in accordance with the disclosure, there is provided a first terminal including one or more processors, and one or more memories storing one or more instructions that, when executed by the one or more processors, cause the first terminal to display an application interface that includes a sharing target selection control and a sharing information selection control, determine at least one type of target information for sharing from at least two types of candidate information of the first terminal in response to receipt of a selection operation on the sharing information selection control, display a list of sharing targets in response to receipt of a selection operation on the sharing target selection control, receive a selection operation on one sharing target in the list of sharing targets, and transmit a share link for obtaining the at least one type of target information to a second terminal corresponding to the one sharing target.

Also in accordance with the disclosure, there is provided a method for information sharing including receiving a share link for obtaining at least one type of target information of a first terminal, transmitted by the first terminal to a second terminal, displaying an application interface on the second terminal in response to receipt of a trigger operation on the share link, and displaying the at least one type of target information in the application interface. The at least one type of target information is selected from at least two types of candidate information of the first terminal through a sharing information selection control on the first terminal.

### BRIEF DESCRIPTION OF THE DRAWINGS

FIG. 1 is a schematic diagram showing an implementation environment according to an exemplary embodiment of this application.

FIG. 2 is a flowchart of a method for information sharing according to an exemplary embodiment of this application.

FIG. 3 is a flowchart of a method for information sharing according to an exemplary embodiment of this application.

FIG. 4 is a flowchart of a method for information sharing according to an exemplary embodiment of this application.

FIG. 5 is a block diagram for a system for information sharing according to an exemplary embodiment of this application.

FIG. 6 is a flowchart of a method for information sharing according to an exemplary embodiment of this application.

FIG. 7 is a schematic diagram showing a process for transmitting a first reminder message involved in the embodiment of FIG. 6.

FIG. 8 is a schematic diagram showing a process for transmitting a private link involved in the embodiment of FIG. 6.

FIG. 9 is an overall framework diagram showing itinerary information sharing according to an exemplary embodiment of this application.

FIG. 10 is a framework diagram showing an itinerary information sharing side according to an exemplary embodiment of this application.

FIG. 11 and FIG. 12 are schematic interface diagrams of an itinerary information sharing side involved in an embodiment of this application.

FIG. 13 and FIG. 14 are schematic interface diagrams of a shared side involved in an embodiment of this application.

FIG. 15 is a block diagram of an apparatus for information sharing according to an exemplary embodiment of this application.

FIG. 16 is a block diagram of an apparatus for information sharing according to an exemplary embodiment of this application.

FIG. 17 is a structural block diagram of a computer device according to an exemplary embodiment of this application.

### DESCRIPTION OF EMBODIMENTS

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations consistent with this application. On the contrary, the implementations are merely examples of apparatuses and methods that are described in detail in the appended claims and that are consistent with some aspects of this application.

“Several” mentioned in the specification means one or more, and “plurality of” mentioned herein means two or more. “And/or” describes an association relationship for describing associated objects and represents that three relationships may exist. For example, A and/or B may represent the following three cases: Only A exists, both A and B exist, and only B exists. The character “/” in this specification generally indicates an “or” relationship between the associated objects.

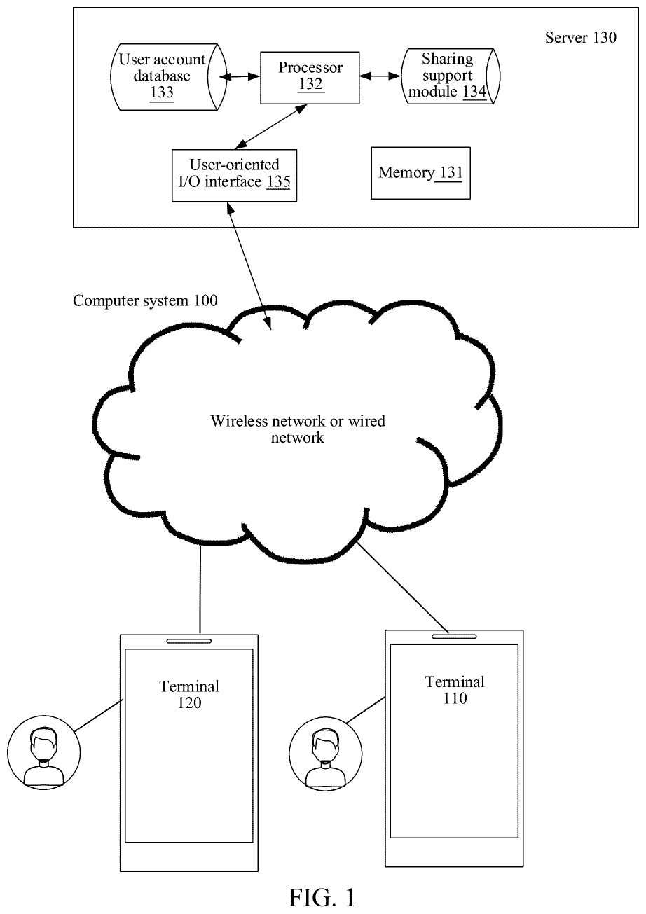

FIG. 1 is a schematic diagram showing an implementation environment according to an exemplary embodiment of this application. The implementation environment may include: a terminal 110, a terminal 120, and a server 130.

The terminal 110 may be a terminal in which a first application is installed and run. For example, the terminal 110 may be a personal computer (PC), a portable computer, a personal workstation, a smartphone, or a tablet.

Applications having an information sharing function and/or information receiving function are installed and run in the terminal 110 and the terminal 120.

In one embodiment, the first application in the terminal 110 has an information sharing function, and the second application in the terminal 120 has an information receiving function. The first application and the second application may be a same application or different applications.

The terminal 110 may share one or more types of information from the terminal 110 with the terminal 120 through a share link by using the first application. The terminal 120 receives the share link by using the second application, obtains the one or more types of information from the terminal 110, and displays the one or more types of information. Information to be shared in the terminal 110 and a sharing target (that is, the terminal 120) may be selected by a user of the terminal 110.

An information sharing support service is run on the server 130, and the information sharing support service is used for providing back-end support for information sharing between the terminal 110 and the terminal 120.

In FIG. 1, only the terminal 110 and the terminal 120 are shown, but in different embodiments, more terminals may access the server 130, so that information sharing and reception between three or more terminals is implemented. For example, the terminal 110 may share information with at least two terminals.

The terminal 110 and the terminal 120 are connected to the server 130 by using a wireless network or a wired network.

The server 130 may be at least one of: one server, a server cluster formed by multiple servers, a cloud computing center, or a virtualized center.

In one exemplary example, the server 130 includes a memory 131, a processor 132, a user account database 133, a sharing support module 134, and a user-oriented input/output interface (I/O interface) 135. The processor 132 is configured to load an instruction stored in the server 130 and process data from the user account database 133 and the sharing support module 134. The user account database 133 is configured to store data of user accounts, such as avatars of user accounts, nicknames of the user accounts, grades of the user accounts, and location of the user accounts, used by the terminal 110, the terminal 120, and other terminals. The sharing support module 134 is configured to provide a back-end service for information sharing. The user-oriented I/O interface 135 is configured to establish communication and exchange data with the terminal 110 and/or the terminal 120 by using a wireless network or a wired network.

Information (including, but not limited to, user account information, user personal information, etc.), data (including, but not limited to, data for analysis, stored data, displayed data, etc.), and signals involved in this application are all authorized by the users or fully authorized by all parties, and the collection, use, and processing of relevant data need to comply with relevant laws, regulations, and standards of relevant countries and regions. For example, information such as user accounts, itinerary related information (for example, location, battery level, communication information), device status, and other information involved in this application are obtained with full authorization.

In one implementation solution, itinerary related information is achieved by using wearable devices such as smartwatches or wristbands. For example, after the elderly wear these physical devices and binding relationships are established with related applications in mobile phones of their children or guardians, their children or guardians can view information such as locations of the elderly in real time in the related applications in the mobile phones.

However, the foregoing solution has problems mainly in three aspects.

First, the elderly need to carry additional devices before traveling, and the elderly may probably forget to carry the devices or find it inconvenient to carry the devices.

Second, after the devices are bound to the applications in the mobile phones of the children or guardians, it is difficult to unbind, and the elderly find it difficult to complete the operation independently; and therefore the assistance by the children or guardians for unbinding is needed.

Third, the traveling information of the elderly can be viewed only by the ones to which the wearable devices are bound, and the elderly cannot freely share the information with others in real time.

The above three problems result in a low efficiency in sharing of itinerary related information.

A subsequent embodiment of this application provides a method for information sharing, which can implement free selection of a sharing target and sharing information through a simple interface interaction, thereby improving the efficiency of information sharing.

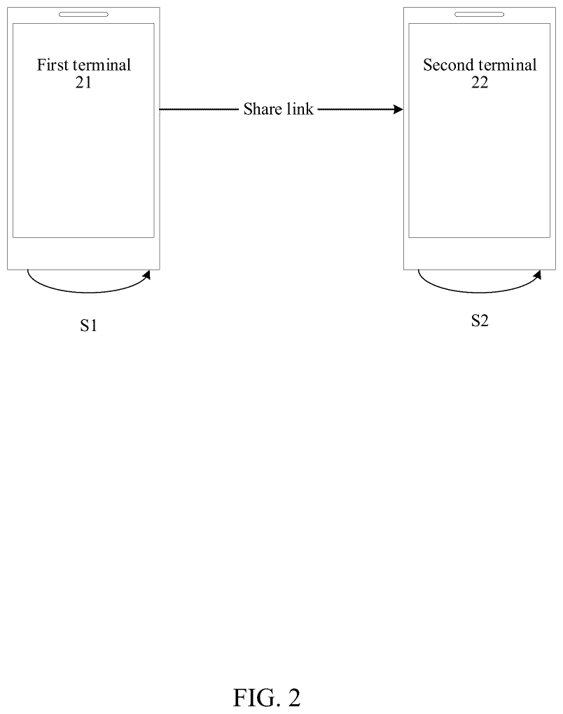

FIG. 2 is a flowchart of a method for information sharing according to an exemplary embodiment of this application. The method for information sharing may be executed by a first terminal 21 and a second terminal 22. The first terminal 21 and a second terminal 22 may be the terminal 110 and the terminal 120 in the system shown in FIG. 1 above. The method includes the following operations.

S1: The first terminal 21 displays a first application interface, the first application interface including a sharing target selection control and a sharing information selection control; determines at least one type of target information for sharing from at least two types of candidate information of the first terminal in response to receipt of a selection operation on the sharing information selection control; displays a list of sharing targets in response to receipt of a selection operation on the sharing target selection control; receives a selection operation on a first sharing target in the list of sharing targets; and transmits a share link to the second terminal corresponding to the first sharing target, where the share link is used for the second terminal to obtain and display the at least one type of target information of the first terminal.

In one possible implementation, the first application interface is an interface in the first application.

The at least two types of candidate information may include at least two of information such as device status information, location information, communication information, and status information corresponding to a user of the first terminal. A specific type of the candidate information is not limited in this embodiment of this application.

The user of the first terminal may select at least one type of target information from the at least two types of candidate information by using the sharing information selection control to share the at least one type of target information with another sharing target.

In one possible implementation, in response to a selection operation on the sharing information selection control, the first terminal displays a list of sharing information, and the list of sharing information includes at least two types of candidate information available for sharing. In response to receipt of a selection operation on candidate information in the list of sharing information, the first terminal determines the selected candidate information as the target information.

Certainly, in other possible implementations, when no selection operations on the sharing information selection control are received, and a selection operation on the sharing target selection control is received, the first terminal determines the candidate information selected in previous sharing as the target information.

In one possible implementation, the list of sharing targets may include options of one or more sharing targets. The sharing target may be a contact object in the first application, or the sharing target may be a contact object in the second application other than the first application.

In one possible implementation, the first terminal may transmit a share link to the second terminal through the first application; or, the first terminal may transmit a share link to the second terminal through a second application other than the first application.

In one possible implementation, when the user of the first terminal simultaneously or sequentially selects a plurality of sharing targets, share links transmitted by the first terminal to second terminals respectively corresponding to the different sharing targets may be different; or, the first terminal may transmit a same share link to second terminals respectively corresponding to different sharing targets.

S2: The second terminal 22 receives the share link transmitted by the first terminal; displays a second application interface in response to receipt of a trigger operation on the share link; and displays the at least one type of target information of the first terminal in the second application interface.

In this embodiment of this application, the second terminal may display the share link after receiving the share link. For example, the second terminal displays the share link in form of a card message. A display method of the share link is not limited in this embodiment of this application.

In this embodiment of this application, after a user corresponding to the second terminal performs a trigger operation on the share link, the second terminal may turn from an interface displaying the share link to the second application interface.

The interface displaying the share link and the second application interface may be interfaces of different applications, or may be interfaces of a same application.

In this embodiment of this application, the first terminal may upload the at least one type of target information to a server, and the second terminal may obtain the at least one type of target information of the first terminal from the server.

In summary, by the solutions in the embodiments of this application, the first terminal displays the first application interface including the sharing target selection control and the sharing information selection control and upon receipt of the selection operation on the sharing target selection control, transmits the at least one type of target information selected from the at least two types of candidate information of the first terminal through the sharing information selection control to the second terminal corresponding to the first sharing target selected from the list of sharing targets through the share link, so that personalized selection of a sharing target and shared content is implemented and the efficiency of information sharing is expanded.

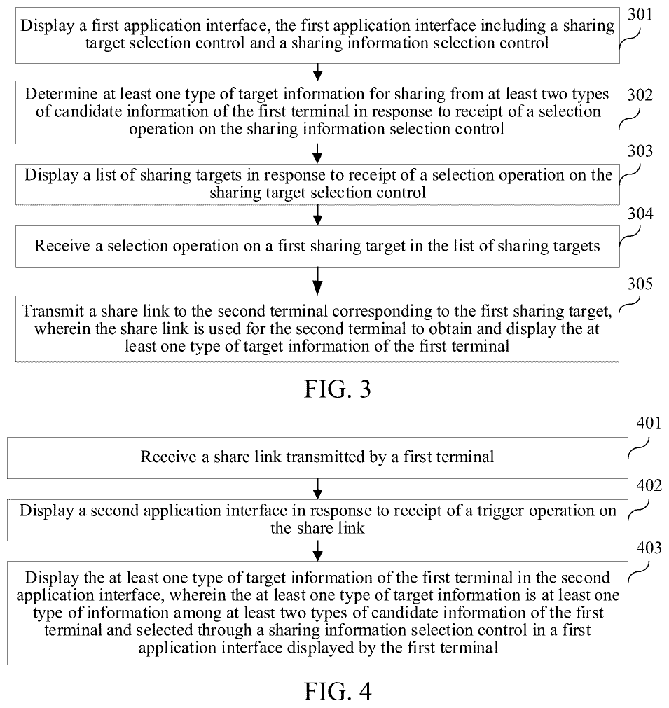

FIG. 3 is a flowchart of a method for information sharing according to an exemplary embodiment of this application. The method for information sharing may be executed by a first terminal. The first terminal may be the terminal 21 in FIG. 2 above. As shown in FIG. 3, the method for information sharing includes the following operations.

Operation 301: Display a first application interface, the first application interface including a sharing target selection control and a sharing information selection control. In this disclosure, the “sharing information” refers to information to be shared, and the “sharing target” refers to a target or object that the information is to be shared with.

Operation 302: Determine at least one type of target information for sharing from at least two types of candidate information of the first terminal in response to receipt of a selection operation on the sharing information selection control.

Operation 303: Display a list of sharing targets in response to receipt of a selection operation on the sharing target selection control.

Operation 304: Receive a selection operation on a first sharing target in the list of sharing targets. The first sharing target is also referred to as a “selected sharing target” or a “target sharing target.”

There is no strict chronological order between operation 302, operation 303, and operation 304, and in other words, selection of the sharing target may be performed before selection of the sharing information, or selection of the sharing information may be performed before selection of the sharing target.

Operation 305: Transmit a share link to a second terminal corresponding to the first sharing target, where the share link is used for the second terminal to obtain and display the at least one type of target information of the first terminal.

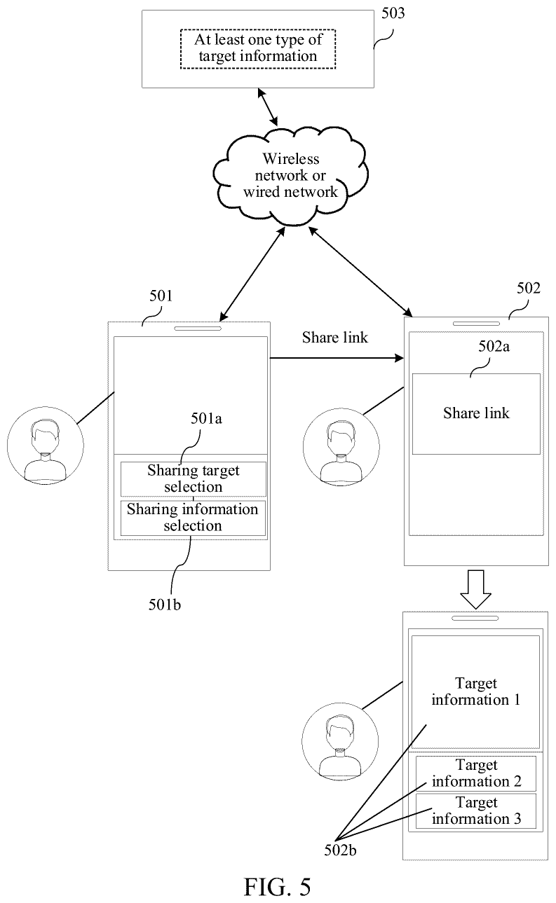

FIG. 4 is a flowchart of a method for information sharing according to an exemplary embodiment of this application. The method for information sharing may be executed by a second terminal. The second terminal may be the terminal 22 in FIG. 2 above. As shown in FIG. 4, the method for information sharing includes the following operations.

Operation 401: Receive a share link transmitted by a first terminal.

Operation 402: Display a second application interface in response to receipt of a trigger operation on the share link.

Operation 403: Display the at least one type of target information of the first terminal in the second application interface, where the at least one type of target information is at least one type of information among at least two types of candidate information of the first terminal and selected through a sharing information selection control in a first application interface displayed by the first terminal.

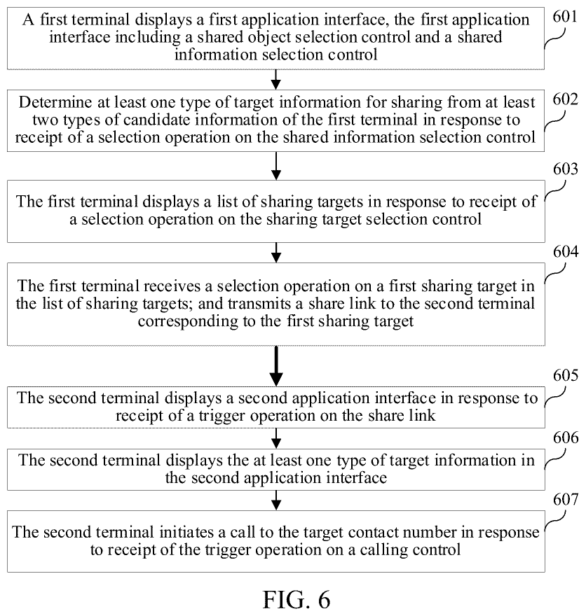

FIG. 5 is a block diagram for a system for information sharing according to an exemplary embodiment of this application. The system architecture includes a first terminal 501, a second terminal 502, and a server 503. A sharer user selects a first sharing target by using a sharing target selection control 501a in a first share interface displayed on the first terminal 501, and selects at least one type of target information by using a sharing information selection control 501b in the first share interface. Then, the first terminal 501 uploads the at least one type of target information of the first terminal 501 to the server 503 for storage, and the first terminal 501 transmits a share link 502a (which may be directly transmitted or forwarded through a server) to the second terminal 502 corresponding to the first sharing target. The second terminal 502 displays the share link 502a. After the user corresponding to the first sharing target taps on the share link 502a, the second terminal 502 displays the second application interface and obtains at least one type of target information 502b from the server 503, and displays at least one type of target information 502b in the second application interface.

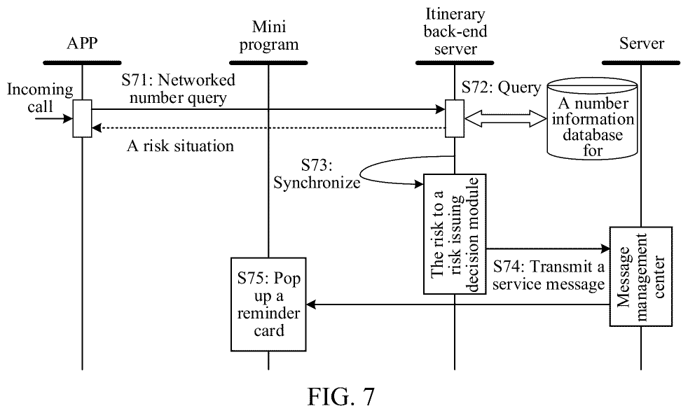

FIG. 6 is a flowchart of a method for information sharing according to an exemplary embodiment of this application. The method for information sharing may be executed by a first terminal and a second terminal. The first terminal and the second terminal may be the terminal 21 and the terminal 22 in FIG. 2 above. As shown in FIG. 6, the method for information sharing may include the following operations.

Operation 601: A first terminal displays a first application interface, the first application interface including a sharing target selection control and a sharing information selection control.

In the solution shown in this embodiment of this application, the at least two types of candidate information available for sharing include at least two types of the following information:
location information of the first terminal, where the location information is used for representing a location or place of the terminal, and for example, the location information may include geographic coordinates of the first terminal, a point of interest (Pol) where the first terminal is located, etc.;
device status information of the first terminal, where the device status information may include battery status information (for example, high battery or low battery) of the first terminal, sensor status information (for example, steady state, falling state, running state), etc.;
communication information of the first terminal, where the communication information of the first terminal may include a communication record, for example, a telephone communication record or an SMS communication record, of the first terminal;
and itinerary information of the first terminal, where the itinerary information of the first terminal may include a departure place, a destination place, a departure time, an arrival time, an itinerary route, etc. of an itinerary set in the first terminal.

Operation 602: Determine at least one type of target information for sharing from at least two types of candidate information of the first terminal in response to receipt of a selection operation on the sharing information selection control.

In one embodiment, in an exemplary solution, the sharing information selection control in the first application interface may include an on/off option corresponding to each type of candidate information, and when the on/off option of a particular type of candidate information is set to “on,” the candidate information is selected as one type of the target information; and on the contrary, when the on/off option of the candidate information is set to “off,” the candidate information is not selected as the target information. The on/off status of the respective types of candidate information may be changed by a user.

Alternatively, the sharing information selection control may be implemented in other forms. An implementation form of the sharing information selection control is not limited in this embodiment of this application. For example, the sharing information selection control may be a button control. After a user taps on the button control, the first terminal may display a list including options respectively corresponding to at least two types of candidate information. The user selects one or more types of target information by using the list, where a name of the selected target information may be displayed in the first application interface.

Operation 603: The first terminal displays a list of sharing targets in response to receipt of a selection operation on the sharing target selection control.

In this embodiment of this application, after the user of the first terminal taps on the sharing target selection control, the list of sharing targets may be displayed. The list of sharing targets may be a list of objects in an application corresponding to the first application interface, or may be a list of objects in another application (for example, an instant messaging application). The user may select, from the list of sharing targets, an object to be shared with, for example, selecting a plurality of sharing targets at once by checking the sharing targets.

Operation 604: The first terminal receives a selection operation on a first sharing target in the list of sharing targets; and transmits a share link to the second terminal corresponding to the first sharing target.

The first sharing target may refer to one sharing target or a plurality of sharing targets.

The share link is used for the second terminal to obtain and display the target information of the first terminal.

In some embodiments, the first application interface is an interface in a first application; and the first sharing target is a contact object in a second application.

In this embodiment of this application, after the user selects at least one first sharing target by using the list of sharing targets, a share link may be generated and transmitted to the second terminal corresponding to the first sharing target.

The first terminal may transmit the share link through an application corresponding to the first application interface, or the first terminal may transmit the share link through another instant messaging application other than the application corresponding to the first application interface.

In one possible implementation, the first application interface may further include: a contact information setting option.

The first terminal may further obtain a target contact number in response to receipt of a setting operation on the contact information setting option. Correspondingly, when a contact number is set, the share link is further used for the second terminal to obtain the target contact number.

The contact number may be a contact number of the first terminal, or may be a contact number of another terminal other than the first terminal, for example, the contact number may be a contact number of an emergency contact person of the user corresponding to the first terminal.

The share link can not only be transmitted to the first sharing target upon triggering by the user, but also can be automatically transmitted to a designated sharing target by the first terminal in a specific scenario.

In one possible implementation, the first terminal transmits the share link to a third terminal corresponding to a designated sharing target when first information in the at least one type of target information meets a first designation condition, the first sharing target does not include the designated sharing target, and sharing of the target information is still lasting.

In one possible implementation, whether the sharing of the target information ends may be manually set at the first terminal. In other words, the user of the first terminal may set starting and ending of the sharing. Alternatively, whether the sharing of the target information ends may be automatically determined by the first terminal, where a basis for determining that the sharing ends may be a duration of continuous sharing (for example, ending the sharing after 2 hours of continuous sharing), a condition for ending sharing (for example, ending the sharing when a specific location is arrived at), etc., which is not limited in this embodiment.

At the end of the sharing, the first terminal stops reporting the target information to the server.

The designated sharing target may be a sharing target set in advance in the first terminal. In one embodiment, the designated sharing target and the first sharing target are set through different selection entries.

In this embodiment of this application, when one or more types of information (the first information) in the at least one type of target information of the first terminal meets a designation condition, and the share link is not currently shared with the first sharing target, the share link may be automatically transmitted to a third terminal corresponding to a preset designated sharing target.

In other words, in this embodiment of this application, the share link may be shared with a terminal of a sharing target manually selected by the user of the first terminal, or may be shared with a terminal of a preset sharing target.

In one possible implementation, the first designation condition includes at least one of the following:
1) The first information includes communication information of the first terminal, and a contact object of the communication information is a designated contact object.

In one embodiment, the designated contact object may be an object manually set by the user or an object having a specific attribute automatically identified by the first terminal, and the specific attribute may be a risk attribute.

For example, the designated contact object may be a preset contact object (which may be a contact number, an area code of a designated area, etc.) manually set by the user, or may be a high-risk contact object identified by the first terminal.

For example, if the first terminal receives an unsafe contact (for example, a telecommunications fraud call) within a period of time prior to a current time, the first terminal may transmit a reminder to the second terminal with which the first terminal has recently sharing information.
2) The first information includes location information of the first terminal, and the location information includes designated location information.

In one embodiment, the designated location information may be coordinates or places manually set by the user, or may be places having a specific attribute automatically identified by the first terminal, and the specific attribute may be a risk attribute or a danger attribute.

For example, the designated location information may be a designated place (for example, a park or a bank) manually set by the user, or may be a place having a safety risk identified by the first terminal.

For example, when the first terminal moves to a site that may have a safety problem (for example, near an ATM machine, where a transfer activity due to fraud may occur), the first terminal may transmit a reminder to the second terminal that has recently sharing information with the first terminal.
3) The first information includes device status information of the first terminal, and the device status information indicates that the first terminal is in a designated state.

In one embodiment, the designated state may be a device state manually set by the user, or may be a device state having a specific attribute automatically identified by the first terminal. The specific attribute may be an attitude attribute, a velocity attribute, an acceleration attribute, or the like.

For example, when the first terminal has a relatively low battery level, or when the first terminal detects a violent collision (specifically when an accelerometer detects acceleration of a large value), the first terminal may transmit a reminder to the second terminal with which the first terminal that has recently sharing information.
4) The first information includes itinerary information of the first terminal, and the location information of the first terminal deviates from a route corresponding to the itinerary information.

In one possible implementation, the first terminal obtains a real-time location, determines whether the real-time location is on a route corresponding to the itinerary information, and if a degree of deviation between the real-time location and the route reaches a threshold (for example, if a distance is greater than a distance threshold), determines a route corresponding to deviation itinerary information.

Operation 605: The second terminal displays a second application interface in response to receipt of a trigger operation on the share link.

In this embodiment of this application, the second terminal may display the share link through the application corresponding to the share link, and when receiving a trigger operation on the share link, display a second application interface. The second application interface may be the interface in the application corresponding to the share link, the interface in the subroutine in the application corresponding to the share link, or, it can also be the interface of other applications other than the application corresponding to the share link.

Operation 606: The second terminal displays the at least one type of target information in the second application interface, where

the at least one type of target information is at least one type of information among at least two types of candidate information of the first terminal and selected through a sharing information selection control in a first application interface displayed by the first terminal.

In this embodiment of this application, the first terminal may report the target information to a cloud server after transmitting the share link, and the cloud server transmits the share link to the second terminal for displaying in the second application interface. Correspondingly, after the second terminal displays the second application interface, the target information may be requested from the server and displayed.

In some embodiments, the second application interface may be an interface in the second application.

The interface displaying the share link in the second terminal and the second application interface may be interfaces of different applications, or may be interfaces of a same application. Alternatively, the application corresponding to the second application interface may be a sub-application of the application corresponding to the interface displaying the share link in the second terminal. The sub-application refers to a program that runs depending on a mother program. For example, the mother program is an instant messaging application, and the sub-application is a mini program.

In one possible implementation, the first terminal transmits the at least one type of target information of the first terminal to the server; when detecting that first information in the at least one type of target information meets the first designation condition, the server may transmit a first reminder message of the first information to the second terminal; and correspondingly, the second terminal receives the first reminder message and displays the first reminder message in a third application interface.

In one embodiment, when transmitting the first reminder message of the first information to the second terminal, the server may transmit the first reminder message of the first information to a target terminal; the target terminal is a second terminal that has received the share link transmitted by the first terminal within a target period of time; and the target period of time is a period of time having a designated duration before a current moment.

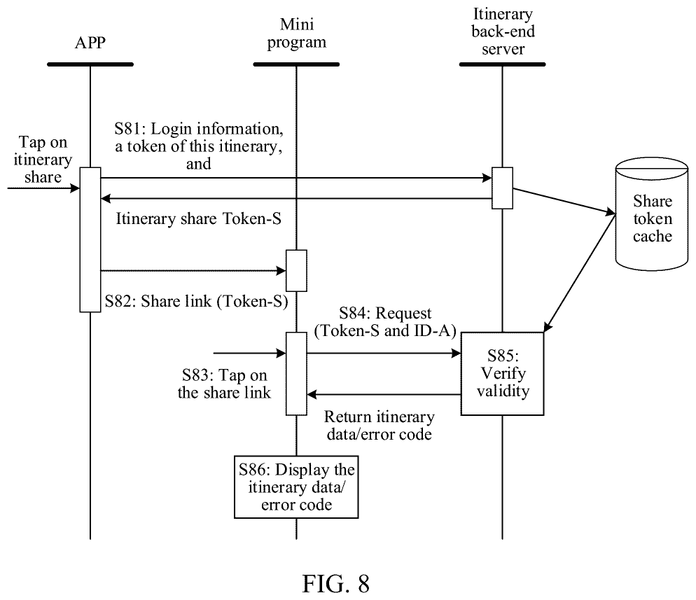

For example, an itinerary user APP is installed in the first terminal and a mini program (that is, a sub-application) of an itinerary follower is installed in the second terminal. Referring to FIG. 7, FIG. 7 is a schematic diagram showing a process for transmitting a first reminder message involved in an embodiment of this application. As shown in FIG. 7, the process for transmitting a first reminder message may include the following operations:
S71: After an itinerary user enables a risk incoming call function, when the itinerary user receives an incoming call in an itinerary, an App end obtains an incoming call number A and performs networked number query by using an itinerary back-end server of a cloud end.
S72: After receiving a number query request, the itinerary back-end server queries a number information database for the number A, to determine whether the number A is a risk type number, such as fraud or harassment. After the query is completed, a query result of the number A is returned to the App end.
S73: If the query result of the incoming call number A indicates a risk, the itinerary back-end server synchronizes the risk to a risk issuing decision module, which is mainly responsible for a risk notification frequency control policy and itinerary follower management, and if an issuing condition is met, pushes a risk message to a message management center of a server.
S74: The message management center in the server receives the message, and transmits a service message to a mini program end of an itinerary subscriber.
S75: A message center of the mini program end of the itinerary subscriber pops up a reminder card related to a risk incoming call in this itinerary.

In one possible implementation, the second terminal may further receive a second reminder message transmitted by the server; the second reminder message is a message transmitted by the server when the first terminal has an anomaly and stops sharing of the at least one type of first information; and the second terminal displays the second reminder message in the third application interface.

The first terminal has an anomaly and stops sharing of the at least one type of first information; for example, that first terminal has an anomaly and stops sharing of the at least one type of first information may refer to that the first terminal stops sharing of the at least one type of first information due to an abnormal interruption of a network connection thereof.

In this embodiment of this application, when the first terminal has an anomaly and stops sharing of the at least one type of first information, the server can still transmit a reminder to the second terminal, so that the sharing target corresponding to the second terminal can timely learn about a relevant situation of the object corresponding to the first terminal.

Upon receipt of a trigger operation on the first reminder message or the second reminder message, the second terminal may turn to a details page corresponding to the first reminder message or the second reminder message.

To avoid information leakage caused by the target information of the first terminal being obtained by an object other than the first sharing target or the designated sharing target, in one possible implementation, the share link may be a private link for each second terminal; in other words, after the second terminal forwards the share link to another terminal, the another terminal cannot open the share link, and further cannot obtain and display the target information of the first terminal.

In one possible implementation, the transmitting, by the first terminal, a share link to the second terminal corresponding to the first sharing target in response to receipt of a selection operation on a first sharing target in the list of sharing targets includes:

obtaining, by the first terminal, first identification information from a server, where the first identification information corresponds to at least one type of target information in the server; generating the share link including the first identification information; and transmitting the share link to the second terminal corresponding to the first sharing target, where the first identification information is used for binding a private terminal of the share link in the server; the private terminal is a terminal that receives the trigger operation on the share link for the first time; binding status between the first identification information and the private terminal is used for the server to authenticate an information obtaining request; and the information obtaining request is a request for obtaining the target information through the share link.

In one embodiment, before obtaining the first identification information from the server, the first terminal may obtain second identification information from the server, where the second identification information is used for identifying at least one type of target information of the first terminal in the server. Subsequently, after determining the first sharing target, the first terminal may transmit a request carrying the second identification information to the server when obtaining the first identification information from the server, and the server generates the first identification information according to the second identification information and returns the first identification information to the first terminal.

Correspondingly, the second terminal transmits an information obtaining request to the server in response to receipt of the trigger operation on the share link before the displaying the at least one type of target information of the first terminal in the second application interface, where the information obtaining request carries the first identification information and identification information of the second terminal; and receives the at least one type of target information transmitted by the server after authenticating the information obtaining request.

On a server side, the server may receive the at least one type of target information transmitted by the first terminal; and correspondingly, the server may generate the second identification information for the at least one type of target information of the first terminal. After receiving the request transmitted by the first terminal for obtaining the first identification information, the server may generate the first identification information according to the second identification information and return the first identification information to the first terminal.

Subsequently, upon receipt of the information obtaining request transmitted by the second terminal, the server may determine whether identification information of a terminal bound to the first identification information in the information obtaining request exists in the server; if the identification information does not exist, establish a binding relationship between the first identification information and the identification information of the second terminal; and determine whether authentication of the information obtaining request is successful; if the identification information of the terminal bound to the first identification information in the information obtaining request already exists in the server, and the identification information of the terminal bound to the first identification information is the identification information of the second terminal, the server determines that the authentication of the information obtaining request is successful and returns the at least one type of target information of the first terminal to the second terminal; If the identification information of the terminal bound to the first identification information in the information obtaining request already exists in the server, and the identification information of the terminal bound to the first identification information is not the identification information of the second terminal, the server determines that the authentication of the information obtaining request fails and returns an error prompt to the second terminal.

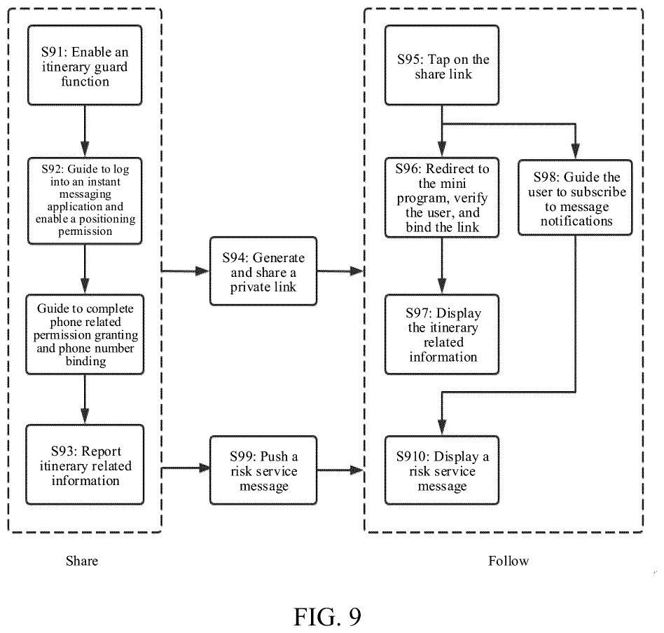

For example, in an itinerary sharing scenario, still, an itinerary user APP is installed in a first terminal and mini program of an itinerary follower is installed in a second terminal. Referring to FIG. 8, FIG. 8 is a flowchart of a process for transmitting a private link involved in an embodiment of this application. As shown in FIG. 7, the process may include the following operations.

S81: An itinerary user taps on itinerary share, and this operation initiates a network request to an itinerary back-end server, for requesting to carry login information (for example, a user identity, or a login token) and an itinerary token this time; the server returns an itinerary share Token-S this time; each time the share is tapped on, a unique itinerary share token bound to the itinerary this time is returned.

A specific algorithm for generating the share token includes the following.
1) String S=md5 (16 bytes) of itinerary token+current server time (8 bytes)+1 byte of random code;
2) binary code M=binary code converted from a string in accordance with a UTF_8 encoding format; and
3) share token=binary code M subject to Base64 encoding processing.
S82: Share the itinerary share Token-S as a parameter of a share link of the mini program, together with the link, with an itinerary follower through an SDK mini program card share interface.
S83: The itinerary follower taps on the share link in a chat window to turn to the itinerary mini program.
S84: The itinerary mini program retrieves the itinerary share Token-S carried in an entry parameter, and a current mini program user ID ID-A, and requests itinerary data from the itinerary back-end server, where requesting parameters carry the itinerary share Token-S and the ID-A.
S85: After receiving the request, the itinerary back-end server verifies validity of the carried itinerary share Token-S and mini program user ID-A. By accessing an itinerary share token cache, whether the itinerary share Token-S has been bound by a mini program user is queried; if the itinerary share Token-S is not bound by a mini program user, the itinerary share Token-S is bound to the mini program user ID-A, and by using the itinerary share Token S, an itinerary user X is reversely resolved, and itinerary data of the itinerary user X is returned; if the itinerary share Token-S has been already bound by a mini program user, whether the bound mini program user ID is consistent with the mini program user ID-A is further determined; if consistent, an itinerary user X is reversely resolved by using the itinerary share Token-S, and itinerary data of the itinerary user X is returned; and otherwise, an error code is returned.

In one possible implementation, an algorithm for reversely resolving the user X by using the share Token-S is in the following.
1) Binary code M=share Token undergone Base64 decoding processing;
2) string S=string converted from binary code M in accordance with a UTF_8 encoding format;
3) md5 of the itinerary Token=first 16 bytes retrieved from the string;
4) reversely looking up the itinerary Token by using md5 of the itinerary Token; and
5) mapping the itinerary user X from the itinerary Token by using an itinerary mapping table.

S86: An itinerary follower mini program end displays itinerary information of the itinerary user according to the itinerary data returned in operation S65.

Operation 607: The second terminal initiates a call to the target contact number in response to receipt of the trigger operation on a call control.

The target contact number is a contact number obtained by the first terminal upon receipt of the setting operation on the contact information setting option in the first application interface.

In this embodiment of this application, when the user of the first terminal sets a target contact number, the user of the second terminal may further initiate a call to the target contact number by using the call control in the second application interface.

In one possible implementation, the first application interface further includes a call control corresponding to the first sharing target; and the method further includes:
displaying, by the first terminal, a call interface for a voice call or video call corresponding to the first sharing target in response to receipt of a trigger operation on the call control.

In one possible implementation, the first application interface is an interface in the first application; the first sharing target is a contact object in a second application; the first application and the second application are different applications; and
the displaying, by the first terminal, a call interface for a voice call or video call corresponding to the first sharing target in response to receipt of a trigger operation on the call control includes:
invoking, by the first terminal, the second application and displaying the call interface in the second application in response to receipt of the trigger operation on the call control.

In this embodiment of this application, the sharing target may be a contact object in the second application, and the second application may be an instant messaging application other than the first application; and when the first terminal receives the trigger operation on the call control corresponding to the first sharing target, the second application may be opened to directly display the call interface corresponding to the first sharing target in the second application, so as to request connection of a voice call or a video call with the first sharing target.

In this embodiment, by setting the share link as a private link and authenticating, by the server, the terminal that requests for obtaining the target information, only a specific sharing target can obtain the target information, which helps to avoid information leakage from the first terminal and further improve the degree of safety of information sharing.

In addition, the first terminal can automatically transmit a share link to a preset sharing target when identifying that the target information meets a specific condition, thereby avoiding the problem that important information cannot conveyed to the sharing target due to incomplete settings during manually setting of the sharing target.

In an exemplary solution based on the method embodiment, by combining application level data obtaining and security guard capabilities of a mobile phone butler app on a mobile phone end, sharing and attention capabilities of an itinerary guard mini program on an instant messaging application end, and map positioning and navigation capabilities on an H5 end, and by connecting functional services by using a cloud instruction, multi-end interactions are implemented. Users and guardians thereof are provided with functional services of real-time traveling location viewing, accurate risk incoming call notification, secure private itinerary share link, and real-time information sharing services for multiple people and terminals, so as to jointly guard the traveling safety of the users and avoid the situations such as being induced by telecommunications fraud before an itinerary, and various types of sudden itinerary risks such as user missing, getting lost, and falling during an itinerary. In addition, information of a final itinerary point after the itinerary ends is obtained.
1) Before the itinerary, an itinerary guard service on a mobile phone app end is enabled actively by a monitored party such as the elderly (or children, or women living alone) or manually by a monitoring party, to generate a private itinerary share link for this itinerary, and the monitoring party such as the offspring (or parents) are shared with the private itinerary share link through an instant messaging app, and are informed of start place and time of the itinerary through a mini program service notification in the instant messaging app.
2) During the itinerary, the guardians such as the offspring (or parents) may: open the private link generated for this itinerary on the instant messaging application, to conveniently view, in real time, a real-time traveling route and location of the monitored party such as the elderly (or children, women living alone), thereby avoiding the situations such as missing or getting lost; check a current battery level of the mobile phone of the monitored party, thereby avoiding disconnection or reminding the monitored party to charge the mobile phone in a timely manner; check information of a risk incoming call in the past 12 hours, to determine whether the monitored party is currently at risk of being deceived; and after making a comprehensive judgment in combination with the information above, if the monitored party has any traveling risk, perform necessary phone contact and communication through the mini program end of the monitoring party.
3) After the itinerary, the monitoring party may be informed of the end place and time of the itinerary through a mini program service notification of the instant messaging application, so that the place and a search range of the monitored party can be quickly determined in case of unexpected traveling risks such as missing.

Through the solution above, the guardian is provided with a comprehensive product solution for remotely guarding the traveling safety of the monitored party.

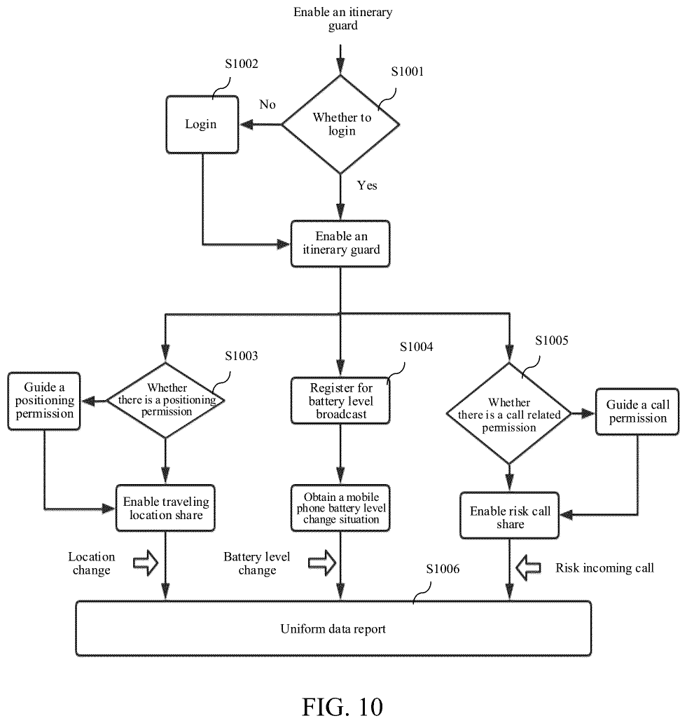

Referring to FIG. 9, FIG. 9 is an overall framework diagram showing itinerary information sharing according to an exemplary embodiment of this application. As shown in FIG. 9, the overall framework in the following.
S91: An itinerary user enters an application App through a mobile phone desktop icon and enables an itinerary guard function by tapping.
S92: Guide the user to log in to an instant messaging application and enable a positioning permission. Subsequently, the user is guided, through a branch path, to complete non-essential processes such as phone related permission granting and phone number binding.

The App transmits a network request to an itinerary guard service back-end, to obtain a Token-T of this itinerary. The itinerary guard service back-end generates and maintains an itinerary mapping table, so that an itinerary token and itinerary data in a subsequent process can be looked up by using the itinerary mapping table.
S93: Report itinerary related information. The App enables a timed task, by which user battery level, location, and risk call information are read, and transmitted to an itinerary guard back-end server through an encrypted network.
S94: Generate and share a private link. When the itinerary user taps on the itinerary share, this operation is to be connected to the itinerary guard service back-end. The request carries the Token-T of this itinerary, to obtain a share token-S of this itinerary. Hereinafter, the itinerary share Token-S is concatenated as a parameter into the share link of the instant messaging application. The share link of the instant messaging application=fixed link+itinerary share Token-S. The itinerary share Token-S can only be bound by one itinerary mini program user. After the binding is completed, the itinerary share token-S automatically becomes invalid. In other words, if a user of the current instant messaging application taps on the share link and then forwards it to a user of another instant messaging application, the user of the another instant messaging application cannot view information of this itinerary.
S95: A user of the instant messaging application taps on the share link on the instant messaging application side, then through the link, an itinerary mini program is automatically redirected to, the mini program guides the current user of the instant messaging application to complete an itinerary message subscription service, and in addition, the user of the instant messaging application automatically becomes a follower of this itinerary.
S96: Redirect to the mini program, verify the user, and bind the link. The itinerary mini program may carry a current mini program user ID and the itinerary share Token-S for networked request for itinerary user data. After receiving the itinerary data request, the itinerary guard back-end first verifies a binding relationship between the current mini program user ID and the itinerary share Token-S. If the verification is successful, an itinerary user X associated with the itinerary share Token-S is reversely resolved, and itinerary related information such as location information, the number risk calls (which may not be available), a battery level of the itinerary user X is returned; if the verification fails, an error code is returned.
S97: After receiving the itinerary information returned from the itinerary guard service back-end, the itinerary mini program displays the itinerary related information of the itinerary user X.
S98: Guide the user to subscribe to message notifications. The itinerary mini program guides the user to subscribe to risk service messages, such as risk incoming calls.
S99: Push a risk service message. For an itinerary user who has completed granting of call related permissions, when an incoming call occurs before or during the itinerary (12 hours) of the itinerary user, the app immediately reports the incoming call. After receiving the incoming call report, the itinerary guard service back-end pushes the message to a service message management center of the instant messaging application according to an established distribution policy. The service message management center of the instant messaging application then pushes the message to the mini program of an itinerary follower who has subscribed to itinerary messages.
S910: Display a risk service message.

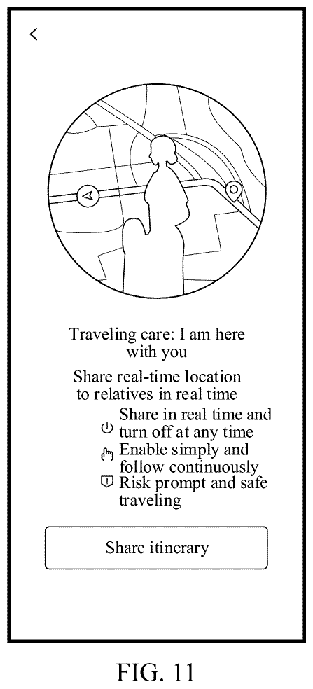

Referring to FIG. 10, FIG. 10 is a framework diagram showing an itinerary information sharing side according to an exemplary embodiment of this application. As shown in FIG. 10, the framework of the itinerary information sharing side is in the following.
S1001: After an itinerary user taps on an itinerary guard function, check whether the current user has logged into an instant messaging application, and if the user has not logged into the instant messaging application or login status of the instant messaging application is expired, turn to S1002.
S1002: Pull up an app side instant messaging application sdk, complete login at the app side instant messaging application, and obtain a current user id and login token.

The app side initiates a network request to an itinerary guard service back-end, where request parameters carry the user ID and the login token. After receiving an itinerary start request, the itinerary guard back-end server checks validity of the current user, and if valid, returns the itinerary token, which means that starting of the itinerary is successfully; and otherwise, returns an error code, which means that starting of the itinerary fails.
S1003: Check whether the current user has a positioning permission; if the positioning permission is not enabled, guide the user to complete granting of the positioning permission, and after the granting of the permission is successful, starting a timed task of obtaining an itinerary location, and enable traveling location sharing.
S1004: Register for system battery level change broadcast detection, to obtain a mobile phone battery level change situation of the current itinerary user.
S1005: This operation is optional. Whether the app end has a call related permission is checked; and if not, the user is guided to enable the function; if not, a risk call detection function is enabled and risk call share is enabled.
S1006: When a location changes, a mobile phone battery level changes, or an incoming call appears, uniformly report the related data obtained in S1003, S1004, and S1005 to the itinerary guard back-end server, where during the reporting, the itinerary token obtained in S1003 needs to be carried, and the itinerary token is for use in data validity verification; if the itinerary token is valid and is not expired, the guard service back-end store this data report for subsequent itinerary data display; or if the itinerary token is invalid or is expired, discard this data report.

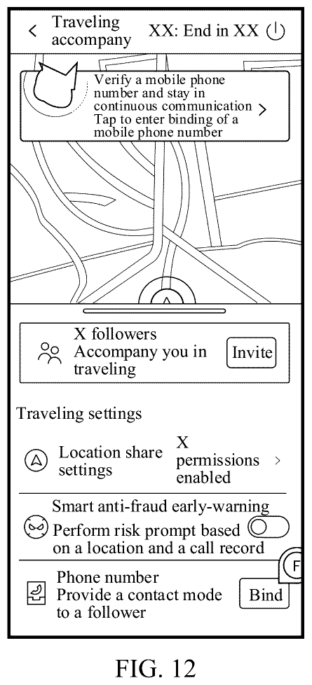

Referring to FIG. 11 and FIG. 12, FIG. 11 and FIG. 12 are schematic interface diagrams of an itinerary information sharing side involved in an embodiment of this application. In the solution of the embodiments of this application, a user enables an itinerary guard service of an application before an itinerary, and the function can be enabled after guiding to complete login to an instant messaging application and granting of a positioning permission. After the itinerary is started, the application displays a map of a current location of the user. The user may share this itinerary with a friend in the instant messaging application. The friend in the instant messaging application may associate a mini program on the instant messaging application end to view information such as a location, a mobile phone battery level, and risk call number of the user. The user may further bind a phone number of the user, so that an itinerary follower can conveniently make a call for communication therewith when necessary.

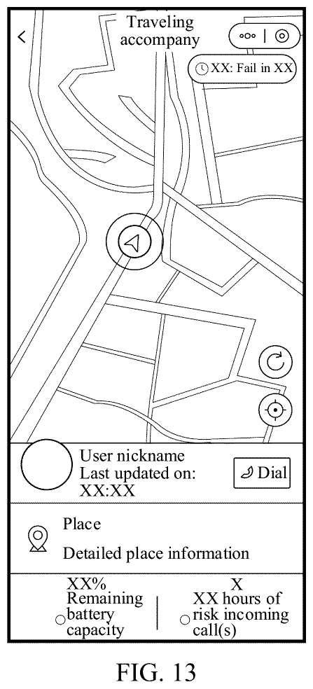

Referring to FIG. 13 and FIG. 14, FIG. 13 and FIG. 14 are schematic interface diagrams of a shared side involved in an embodiment of this application. After receiving itinerary share information, a follower may tap on the private share link on the instant messaging application to pull up an associated mini program. This link is an exclusive link for the follower, and is invalid after being forwarded. After opening the mini program, the follower may view real-time location information, battery level information, and risk call information of a traveling person. In addition, the follower may subscribe to itinerary messages and receive a service message notification from the instant messaging application in a timely manner when an itinerary person receives a risk call or when the itinerary ends abnormally.

The actual demands of the monitored party (such as the elderly population) for autonomous traveling and social interaction are difficult to meet. By the solutions shown in this embodiment of this application, the traveling safety of the monitored party can be guarded under remote guidance or guard by the monitoring party by using real-time positioning and navigation services in the itinerary guard function, so that the s traveling and social interaction demands of the monitored party are met. In addition, by associating risk incoming call information before traveling, being induced to travel by telecommunications fraud before an itinerary is avoided, thereby reducing the risk of property damage; and further various types of sudden itinerary risks such as user missing, getting lost, and falling during an itinerary are also avoided.

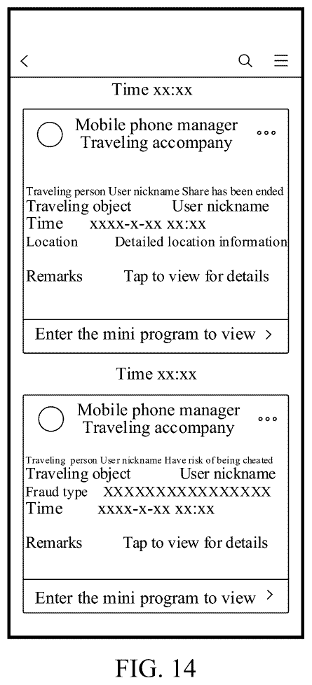

FIG. 15 is a block diagram of an apparatus for information sharing according to an exemplary embodiment of this application. The apparatus for information sharing may be configured to execute all or part of operations performed by a first terminal in the method in FIG. 3 or FIG. 6. As shown in FIG. 15, the apparatus for information sharing may include:
an interface display module 1501, configured to display a first application interface, the first application interface including a sharing target selection control and a sharing information selection control;
an information selection module 1502, configured to determine at least one type of target information for sharing from at least two types of candidate information of a first terminal in response to receipt of a selection operation on the sharing information selection control;
a list display module 1503, configured to display a list of sharing targets in response to receipt of a selection operation on the sharing target selection control;
an object selection module 1504, configured to receive a selection operation on a first sharing target in the list of sharing targets; and
a link transmitting module 1505, configured to transmit a share link to a second terminal corresponding to the first sharing target, where the share link is used for the second terminal to obtain and display the at least one type of target information of the first terminal.

In one possible implementation, the at least two types of candidate information includes at least two of the following information:
location information of the first terminal;
device status information of the first terminal;
communication information of the first terminal;
and itinerary information of the first terminal.

In one possible implementation, the first application interface further includes: a contact information setting option.
the apparatus further includes:
a contact number obtaining module, configured to obtain a target contact number in response to receipt of a setting operation on the contact information setting option, where
when the target contact number is set, the share link is further used for the second terminal to obtain the target contact number.

In one possible implementation, the link transmitting module 1503 is further configured to transmit the share link to a third terminal corresponding to a designated sharing target when first information in the at least one type of target information meets a first designation condition, the first sharing target does not include the designated sharing target, and sharing of the target information is still lasting, where the designated sharing target is a sharing target set in advance in the first terminal.

In one possible implementation, the apparatus further includes:
a reminder transmitting module, configured to transmit a first reminder message of first information to a target terminal in response to the first information in the at least two types of candidate information of the first terminal meets a designation condition, where
the target terminal is a second terminal that has received the share link transmitted by the first terminal within a target period of time; and the target period of time is a period of time having a designated duration before a current moment.

In one possible implementation, the designation condition includes at least one of the following conditions:
the first information includes communication information of the first terminal, and a contact object of the communication information includes a designated contact object;
the first information includes location information of the first terminal, and the location information includes designated location information;
the first information includes device status information of the first terminal, and the device status information indicates that the first terminal is in a designated state; and
the first information includes itinerary information of the first terminal, and the location information of the first terminal deviates from a route corresponding to the itinerary information.

In one possible implementation, the link transmitting module 1503 is configured to:
obtain first identification information from a server, where the first identification information corresponds to at least one type of target information in the server;
generate the share link including the first identification information; and
transmit the share link to the second terminal corresponding to the first sharing target, where
the first identification information is used for binding a private terminal of the share link in the server; the private terminal is a terminal that receives the trigger operation on the share link for the first time; binding status between the first identification information and the private terminal is used for the server to authenticate an information obtaining request; and the information obtaining request is a request for obtaining the target information through the share link.

In one possible implementation, the apparatus further includes:
an information transmitting module, configured to transmit the at least one type of target information to the server.

In one possible implementation, the first application interface further includes a call control corresponding to the first sharing target; and
the apparatus further includes: a call interface display module, configured to display a call interface for a voice call or video call corresponding to the first sharing target in response to receipt of a trigger operation on the call control.

In one possible implementation, the first application interface is an interface in the first application; the first sharing target is a contact object in a second application; the first application and the second application are different applications; and
the call interface display module is configured to invoke the second application and displaying the call interface in the second application in response to receipt of the trigger operation on the call control.

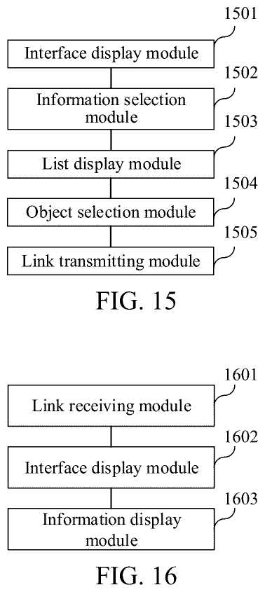

FIG. 16 is a block diagram of an apparatus for information sharing according to an exemplary embodiment of this application. The apparatus for information sharing may be configured to execute all or part of operations performed by a second terminal in the method in FIG. 4 or FIG. 6. As shown in FIG. 16, the apparatus for information sharing may include:
a link receiving module 1601, configured to receive a share link transmitted by a first terminal;
an interface display module 1602, configured to display a second application interface in response to receipt of a trigger operation on the share link; and
an information display module 1603, configured to display at least one type of target information of the first terminal in the second application interface, where the at least one type of target information is at least one type of information among at least two types of candidate information of the first terminal and selected through a sharing information selection control in a first application interface displayed by the first terminal.

In one possible implementation, the at least two types of candidate information includes at least two of the following information:
location information of the first terminal;
device status information of the first terminal; and
communication information of the first terminal.

In one possible implementation, the second application interface further includes: a call control; and
the apparatus further includes: a calling module, configured to initiate a call to the target contact number in response to receipt of the trigger operation on the call control, where
the target contact number is a contact number obtained by the first terminal upon receipt of the setting operation on the contact information setting option in the first application interface.

In one possible implementation, the apparatus further includes:
an information obtaining request transmitting module, configured to transmit an information obtaining request to the server in response to receipt of the trigger operation on the share link before the displaying the at least one type of target information of the first terminal in the second application interface, where the information obtaining request carries the first identification information and identification information of the second terminal;
an information receiving module, configured to receive the at least one type of target information transmitted by the server after authenticating the information obtaining request, where
the share link includes the first identification information; the first identification information corresponds to the at least one type of target information of the first terminal in the server; the first identification information is used for binding a private terminal of the share link in the server; the private terminal is a terminal that receives the trigger operation on the share link for the first time; binding status between the first identification information and the private terminal is used for the server to authenticate an information obtaining request; and the information obtaining request is a request for obtaining the target information through the share link.

In one possible implementation, the apparatus further includes:
a first reminder receiving module, configured to receive a first reminder message transmitted by the server, where the first reminder message is a reminder message for the first information in the at least one type of target information, and the first reminder message is a message transmitted by the server when the first information meets the first designation condition; and
a first reminder display module, configured to display the first reminder message in a third application interface.

In one possible implementation, the first designation condition includes at least one of the following conditions:
the first information includes communication information of the first terminal, and a contact object of the communication information includes a designated contact object;
the first information includes location information of the first terminal, and the location information includes designated location information;
the first information includes device status information of the first terminal, and the device status information indicates that the first terminal is in a designated state; and
the first information includes itinerary information of the first terminal, and the location information of the first terminal deviates from a route corresponding to the itinerary information.

In one possible implementation, the apparatus further includes:
a second reminder receiving module, configured to receive a second reminder message transmitted by the server, where the second reminder message is a message transmitted by the server when the first terminal has an anomaly and stops sharing of the at least one type of first information; and
a second reminder display module, configured to display the second reminder message in a third application interface.

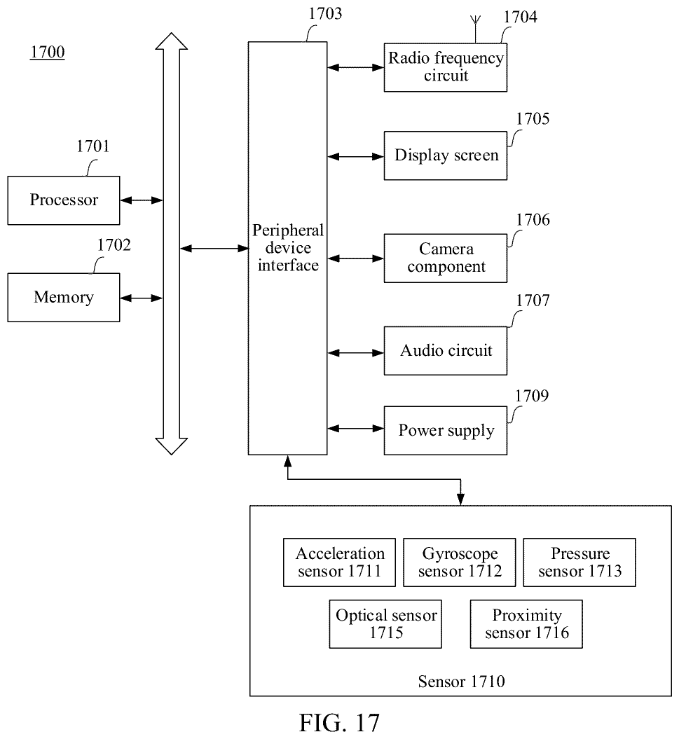

FIG. 17 is a structural block diagram of a computer device 1700 according to an exemplary embodiment of this application. The computer device 1700 may be a terminal of a user, for example, a wearable device, a smartphone, a tablet, or a personal computer.

Typically, The computer device 1700 includes: a processor 1701 and a memory 1702.

The processor 1701 may include one or more processing cores, for example, a 4-core processor or an 8-core processor. The processor 1701 may be implemented in at least one hardware form of a digital signal processor (DSP), a field-programmable gate array (FPGA), and a programmable logic array (PLA).

The memory 1702 may include one or more computer-readable storage media. The computer-readable storage media may be non-transitory. The memory 1702 may further include a high-speed random access memory and a nonvolatile memory, for example, one or more disk storage devices or flash storage devices. In some embodiments, a non-transitory computer-readable storage medium in the memory 1702 is configured to store at least one computer instruction, and the at least one computer instruction is executed by the processor 1701, to implement all or part of the operations performed by the first terminal or the second terminal in the method embodiments provided in the embodiments of this application.

In some embodiments, the computer device 1700 may further include: a peripheral interface 1703 and at least one peripheral. The processor 1701, the memory 1702, and the peripheral interface 1703 may be connected through a bus or a signal line. Each peripheral may be connected to the peripheral interface 1703 through a bus, a signal line, or a circuit board. The peripheral includes: at least one of a radio frequency circuit 1704, a display screen 1705, a camera component 1706, an audio circuit 1707, and a power supply 1709.

In some embodiments, the computer device 1700 may further include one or more sensors 1710. The one or more sensors 1710 include but are not limited to: an acceleration sensor 1711, a gyroscope sensor 1712, a pressure sensor 1713, an optical sensor 1715, and a proximity sensor 1716.

A person skilled in the art may understand that the structure shown in FIG. 17 constitutes no limitation on the computer device 1700, and the computer device 1700 may include more or fewer components than those shown in the figure, or some components may be combined, or a different component deployment may be used.

In one exemplary embodiment, a non-transitory computer-readable storage medium including an instruction, for example, a memory including at least one computer instruction, is further provided. The at least one computer instruction may be executed by a processor to implement all or part of the operations performed by the first terminal or the second terminal in the method provided in any of the embodiments shown in FIG. 3, FIG. 4, or FIG. 6 above. For example, the non-transitory computer-readable storage medium may be a ROM, a RAM, a CD-ROM, a magnetic tape, a floppy disk, and an optical data storage device.

In one exemplary embodiment further provided is a computer program product or a computer program, the computer program product or the computer program including a computer instruction, stored in a computer-readable storage medium. A processor of the computer device reads the computer instruction from the computer-readable storage medium, and the processor executes the computer instruction, to cause the computer device to perform all or part of the operations performed by the first terminal or the second terminal in the method provided in any of the embodiments shown in FIG. 3, FIG. 4, or FIG. 6 above.

Information (including, but not limited to, user account information, user personal information, etc.), data (including, but not limited to, data for analysis, stored data, displayed data, etc.), and signals involved in this application are all authorized by the users or fully authorized by all parties, and the collection, use, and processing of relevant data need to comply with relevant laws, regulations, and standards of relevant countries and regions. For example, the user accounts, schedule activities, and other information involved in this application are obtained with full authorization.

This application is not limited to the precise structures described above and shown in the accompanying drawings, and various modifications and changes may be made without departing from the scope of this application. The scope of this application is subject only to the appended claims.

What is claimed is:

1. A method for information sharing, executed by a first terminal, comprising:
displaying an application interface, the application interface including a sharing target selection control and a sharing information selection control;
determining at least one type of target information for sharing from at least two types of candidate information of the first terminal in response to receipt of a selection operation on the sharing information selection control;
displaying a list of sharing targets in response to receipt of a selection operation on the sharing target selection control;
receiving a selection operation on one sharing target in the list of sharing targets; and
transmitting a share link for obtaining the at least one type of target information to a second terminal corresponding to the one sharing target.

2. The method according to claim 1,
wherein the application interface further includes a contact information setting option;
the method further comprising:
obtaining a target contact number in response to receipt of a setting operation on the contact information setting option;
wherein the share link is further for obtaining the target contact number.

3. The method according to claim 1, further comprising:
transmitting the share link to a third terminal corresponding to a designated sharing target in response to one piece of information in the at least one type of target information meets a designation condition, the one sharing target does not includes the designated sharing target, and sharing of the target information is note completed;
wherein the designated sharing target is set in advance in the first terminal.

4. The method according to claim 3, wherein the designation condition includes at least one of following:
the one piece of information includes communication information of the first terminal, and a contact object of the communication information includes a designated contact object;
the one piece of information includes location information of the first terminal, and the location information includes designated location information;
the one piece of information includes device status information of the first terminal, and the device status information indicates that the first terminal is in a designated state; and
the one piece of information includes itinerary information of the first terminal, and the location information of the first terminal deviates from a route corresponding to the itinerary information.

5. The method according to claim 1, wherein:
transmitting the share link to the second terminal includes:
obtaining identification information from a server, the identification information corresponds to at least one type of target information in the server;
generating the share link including the identification information; and
transmitting the share link to the second terminal; and
the identification information is used for binding a private terminal of the share link in the server, the private terminal is a terminal that receives the trigger operation on the share link for a first time, binding status between the identification information and the private terminal is used for the server to authenticate an information obtaining request, and the information obtaining request is a request for obtaining the target information through the share link.

6. The method according to claim 5, further comprising:
transmitting at least one type of target information to the server.

7. The method according to claim 1,
wherein the application interface further includes a call control corresponding to the one sharing target;
the method further comprising:
displaying a call interface for a voice call or a video call corresponding to the one sharing target in response to receipt of a trigger operation on the call control.

8. The method according to claim 7, wherein:
the application interface is an interface in a first application, the one sharing target is a contact object in a second application, and the first application and the second application are different applications; and
displaying the call interface includes:
invoking the second application and displaying the call interface in the second application.

9. One or more non-transitory computer-readable storage media storing one or more instructions that, when executed by one or more processors, cause the one or more processors to perform the method according to claim 1.

10. A first terminal comprising:
one or more processors; and
one or more memories storing one or more instructions that, when executed by the one or more processors, cause the first terminal to:
display an application interface, the application interface including a sharing target selection control and a sharing information selection control;
determine at least one type of target information for sharing from at least two types of candidate information of the first terminal in response to receipt of a selection operation on the sharing information selection control;
display a list of sharing targets in response to receipt of a selection operation on the sharing target selection control;
receive a selection operation on one sharing target in the list of sharing targets; and
transmit a share link for obtaining the at least one type of target information to a second terminal corresponding to the one sharing target.

11. The first terminal according to claim 10, wherein:
the application interface further includes a contact information setting option; and
the one or more instructions, when executed by the one or more processors, further cause the first terminal to:
obtain a target contact number in response to receipt of a setting operation on the contact information setting option, the share link being further for obtaining the target contact number.

12. The first terminal according to claim 10, wherein:
the one or more instructions, when executed by the one or more processors, further cause the first terminal to transmit the share link to a third terminal corresponding to a designated sharing target in response to one piece of information in the at least one type of target information meets a designation condition, the one sharing target does not includes the designated sharing target, and sharing of the target information is note completed; and
the designated sharing target is set in advance in the first terminal.

13. The first terminal according to claim 12, wherein the designation condition includes at least one of following:
the one piece of information includes communication information of the first terminal, and a contact object of the communication information includes a designated contact object;
the one piece of information includes location information of the first terminal, and the location information includes designated location information;
the one piece of information includes device status information of the first terminal, and the device status information indicates that the first terminal is in a designated state; and
the one piece of information includes itinerary information of the first terminal, and the location information of the first terminal deviates from a route corresponding to the itinerary information.

14. A method for information sharing comprising:
receiving a share link for obtaining at least one type of target information of a first terminal, transmitted by the first terminal to a second terminal;
displaying an application interface on the second terminal in response to receipt of a trigger operation on the share link; and
displaying the at least one type of target information in the application interface;
wherein the at least one type of target information is selected from at least two types of candidate information of the first terminal through a sharing information selection control on the first terminal.

15. The method according to claim 14,
wherein the application interface further includes a call control;
the method further comprising:
initiating, by the second terminal, a call to a target contact number in response to receipt of a trigger operation on the call control.

16. The method according to claim 15, further comprising:
transmitting an information obtaining request to a server in response to receipt of a trigger operation on the share link before displaying the at least one type of target information, the information obtaining request carrying first identification information of the first terminal and second identification information of the second terminal;
receiving the at least one type of target information transmitted by the server after authenticating the information obtaining request;
wherein:
the share link includes the first identification information;
the first identification information corresponds to the at least one type of target information of the first terminal in the server;
the first identification information is used for binding a private terminal of the share link in the server;
the private terminal is a terminal that receives the trigger operation on the share link for a first time;
binding status between the first identification information and the private terminal is used for the server to authenticate the information obtaining request; and
the information obtaining request is a request for obtaining the target information through the share link.

17. The method according to claim 14, further comprising:
receiving a reminder message transmitted by a server, the reminder message being for one piece of information in the at least one type of target information, and the reminder message being transmitted by the server in response to the one piece of information meeting a designation condition; and
displaying the reminder message in another application interface.

18. The method according to claim 14, further comprising:
receiving a reminder message transmitted by a server in response to the first terminal having an anomaly and stopping sharing the at least one type of first information; and
displaying the reminder message in another application interface.

19. One or more non-transitory computer-readable storage media storing one or more instructions that, when executed by one or more processors, cause the one or more processors to perform the method according to claim 14.

20. A second terminal comprising:
one or more processors; and
one or more memories storing one or more instructions that, when executed by the one or more processors, cause the second terminal to perform the method according to claim 14.
